(19) United States
(12) Patent Application Publication
(10) Pub. No.: US 2015/0035778 A1
(43) Pub. Date: Feb. 5, 2015

(54) DISPLAY CONTROL DEVICE, DISPLAY CONTROL METHOD, AND COMPUTER PROGRAM PRODUCT

(71) Applicant: Kabushiki Kaisha Toshiba, Tokyo (JP)

(72) Inventors: Daisuke HIRAKAWA, Saitama-shi (JP); Tomoyuki SHIBATA, Kawasaki-shi (JP)

(21) Appl. No.: 14/445,467

(22) Filed: Jul. 29, 2014

(30) Foreign Application Priority Data
Jul. 31, 2013 (JP) 2013-159853

(51) Int. Cl. G09G 5/37; G06F 3/041

(52) U.S. Cl. CPC G09G 5/37; G06F 3/0416; G09G 2354/00; G09G 2340/0464
USPC 345/173

(57) ABSTRACT

According to an embodiment, a display control device includes a first receiver, a first determination unit, and a display controller. The first receiver is configured to receive coordinate values on a screen, the coordinate values being input in time series in accordance with an operation by a user. The first determination unit is configured to determine a position of a graphic formed by the coordinate values received by the first receiver so that the graphic is put in a non-active region other than a first display region in which a first content indicating a program that is being executed is displayed on the screen, and determine a region of the non-active region in which the graphic is arranged as a second display region. The display controller is configured to control to display a second content indicating a program different from the first content on the second display region.

### CROSS-REFERENCE TO RELATED APPLICATION

This application is based upon and claims the benefit of priority from Japanese Patent Application No. 2013-159853, filed on Jul. 31, 2013; the entire contents of which are incorporated herein by reference.

### FIELD

Embodiments described herein relate generally to a display control device, a display control method, and a computer program product.

### BACKGROUND

In recent years, multi-window operating systems for displaying a plurality of computer programs that are being executed at the same time as a plurality of windows have been applied widely for business use and personal use.

In a device on which the multi-window operating system is mounted, the following techniques have been known. That is, known have been techniques of ensuring a new display region at a certain position in a display screen, changing shapes of allowable graphics of content display regions, and so on in accordance with operations by a user.

### BRIEF DESCRIPTION OF THE DRAWINGS

FIG. 1 is a diagram illustrating an example of the configuration of a display control device according to a first embodiment;

FIG. 2 illustrates an example of a stroke in the first embodiment;

FIG. 3 illustrates the data structures of drawn image data and the stroke in the first embodiment;

FIG. 4 is a view illustrating a first display region and a non-active region in the first embodiment;

FIG. 5 is a view illustrating the first display region and the non-active region in the first embodiment;

FIG. 6 is a view illustrating rectangles circumscribing pieces of drawn image data in the first embodiment;

FIG. 7 is a view illustrating results obtained by recognizing, as graphics, the pieces of drawn image data in the first embodiment;

FIG. 8 is a view for explaining size determination processing in the first embodiment;

FIG. 9 is a view for explaining the size determination processing in the first embodiment;

FIG. 10 is a view for explaining processing by a first determination unit in the first embodiment;

FIG. 11 is a view for explaining the processing by the first determination unit in the first embodiment;

FIG. 12 is a view illustrating a graphic formed by respective coordinate values included in drawn image data according to a modification;

FIG. 13 is a flowchart illustrating an example of operations of the display control device in the first embodiment;

FIG. 14 illustrates a method of changing a first display region in the modification;

FIG. 15 illustrates the method of changing the first display region in the modification;

FIG. 16 is a diagram illustrating an example of the functional configuration of a display control device according to a second embodiment;

FIG. 17 is a view for explaining an example of a method of setting a character input region in the second embodiment; and

FIG. 18 is a flowchart illustrating an example of operations of the display control device in the second embodiment.

### DETAILED DESCRIPTION

According to an embodiment, a display control device includes a first receiver, a first determination unit, and a display controller. The first receiver is configured to receive coordinate values on a screen, the coordinate values being input in time series in accordance with an operation by a user. The first determination unit is configured to determine a position of a graphic formed by the coordinate values received by the first receiver so that the graphic is put in a non-active region other than a first display region in which a first content indicating a program that is being executed is displayed on the screen, and determine a region of the non-active region in which the graphic is arranged as a second display region. The display controller is configured to control to display a second content indicating a program different from the first content on the second display region.

Hereinafter, embodiments of a display control device, a display control method, and a computer program are described in detail with reference to the accompanying drawings.

### First Embodiment

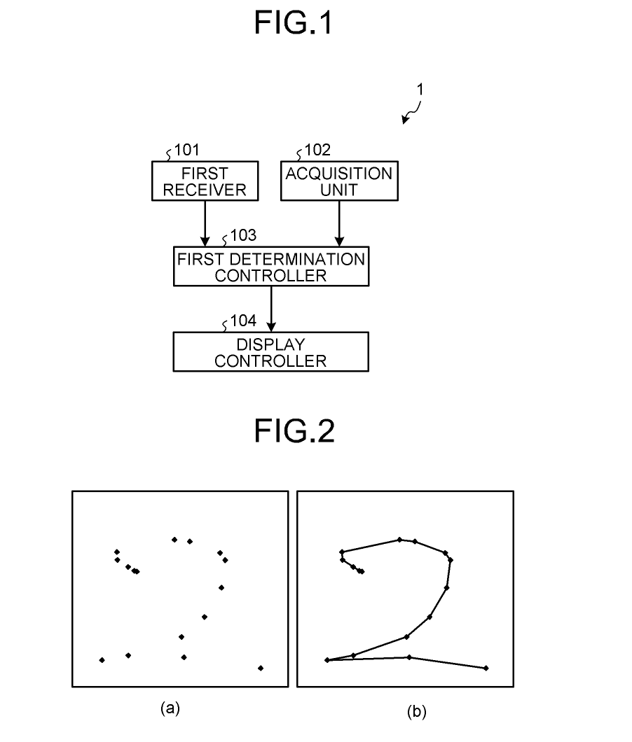

FIG. 1 is a diagram illustrating an example of the functional configuration of a display control device 1 according to a first embodiment. As illustrated in FIG. 1, the display control device 1 includes a first receiver 101, an acquisition unit 102, a first determination controller 103, and a display controller 104. Although not illustrated in FIG. 1, the display control device 1 includes a display device that displays images of various types. The display device can be configured by a touch panel liquid crystal display device or the like. In the following description, a surface of the display device on which images are displayed is referred to as a “screen”.

The first receiver 101 receives coordinate values on the screen that are input in time series in accordance with an operation by a user. To be more specific, the first receiver 101 receives drawn image data formed by equal to or more than one stroke(s) that is(are) input by handwriting. The stroke corresponds to a continuous drawn image. In this example, the stroke indicates a trajectory drawn with a pen or the like until the pen is lifted from a surface (in this example, screen) on which a document is described since the pen or the like has made contact with the surface. The stroke may be input onto the screen by a certain method (certain handwriting input method can be used). Examples thereof include a method of inputting the stroke by moving a pen on a touch panel (or touch pad), a method of inputting the stroke by moving a user's finger on the touch panel, a method of inputting the stroke by operating a mouse, and a method of inputting the stroke by operating an electronic pen. Note that the method is not limited to them. In the embodiment, as the handwriting input method, the stroke is input by moving a pen while making the pen contact with the touch panel (screen) is used as an example.

The stroke is usually obtained by sampling points on the trajectory of the handwriting by the user at predetermined timings (for example, at a constant cycle). In the embodiment, every time the user touches the screen with the pen to start writing, the first receiver 101 performs the sampling at the predetermined timings so as to acquire coordinate values on the screen that form the one stroke. In other words, the first receiver 101 receives the coordinate values on the screen that are input in time series.

FIG. 2 illustrates an example of the acquired stroke. It is assumed that the sampling cycle of the sampled points in the stroke is constant, as an example. In FIG. 2, (a) illustrates the coordinates of the sampled points, and (b) illustrates a point structure that is continuous temporally in a linearly interpolated manner. The intervals between the coordinates of the sampled points are different depending on drawing speeds. The number of sampled points can be different among the respective strokes.

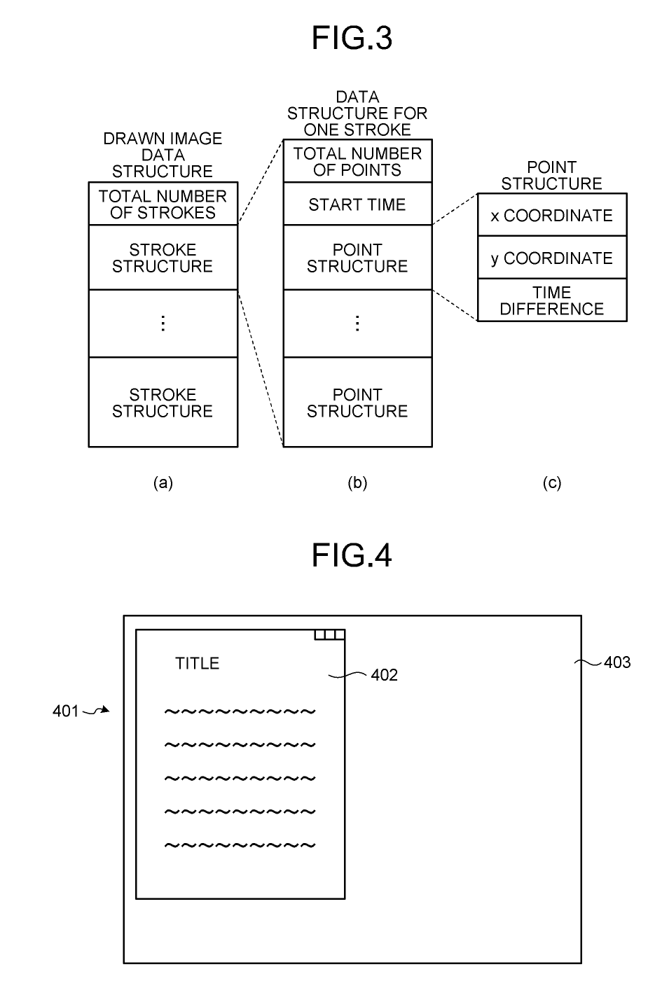

The data structure of the drawn image data and the data structure of the stroke are described. FIG. 3 schematically illustrates the data structure of the drawn image data and the data structure of the stroke. As illustrated in (a) of FIG. 3, the data structure of the drawn image data is a structure including the “total number of strokes” and an array of “stroke structures”. The “total number of strokes” indicates the number of strokes included in the whole region of the screen. The number of “stroke structures” corresponds to the total number of strokes. The stroke structure indicates the data structure for one stroke.

As illustrated in (b) of FIG. 3, the data structure for one stroke is expressed by a set (point structure) of coordinate values on the screen on which the pen is moved. To be more specific, the data structure for one stroke is a structure including the “total number of points”, “start time”, and an array of “point structures”. The “total number of points” indicates the number of points forming the stroke. The number of “point structures” corresponds to the total number of points. The start time indicates time at which the user touches the screen with the pen to start writing on the stroke.

The point structure can depend on an input device. In the example of (c) of FIG. 3, one point structure is a structure having information indicating coordinate values (x, y) at which the point is sampled and time difference from the initial point (for example, the above-mentioned start time). The coordinates are in the coordinate system of the screen and may be in such a form that values thereof are larger to the positive side as they are closer to a lower right corner while an upper left corner is set to a point of origin, for example.

The data indicating the stroke drawn by the user using the pen may be held on a memory (not illustrated) with the data structure as illustrated in FIG. 3, for example. The first receiver 101 may determine that the handwriting input by the user is finished when the pen does not make contact with the screen again even after a predetermined period of time has passed from a time point at which the pen has been lifted from the screen (time point at which input for one stroke has been finished).

Description is continued with reference to FIG. 1, again. The acquisition unit 102 acquires region information from the display controller 104, which will be described later. The region information makes it possible to specify a first display region displaying a first content and a non-active region other than the first display region on the screen. The first content indicates a program that is displayed as a window on the screen and is being executed. It can be also considered that the first display region is a region assigned to the first content on the screen. When the first content is not present, the acquisition unit 102 acquires region information specifying the whole region on the screen as the non-active region. Furthermore, various pieces of information can be used as the information specifying the first display region in the region information. For example, the information specifying the first display region may be configured by at least equal to or more than one coordinate group(s) (x1, y1), (x2, y2), (x3, y3), (x4, y4), (x5, y5), . . . , and (xn, yn) included in the window corresponding to the first content. Alternatively, the information specifying the first display region may be configured by upper left coordinates (x, y) of a rectangle circumscribing the window, information indicating a width w, and information indicating a height h.

FIG. 4 is a plan view schematically illustrating an example of the first display region and the non-active region. Reference numeral 401 in FIG. 4 denotes the whole screen. Reference numeral 402 in FIG. 4 denotes the first display region displaying the first content (window corresponding to a program that is being executed). Various contents can be used as the first content. Examples thereof include a content capable of inputting text, a content capable of calculating numerals, a content capable of forecasting the weather, and a content on which an enter button is arranged.

Reference numeral 403 in FIG. 4 denotes the non-active region. In FIG. 4, when it is assumed that the area of the whole screen 401 is 401A, the area of the first display region 402 is 402A, and the area of the non-active region 403 is 403A, a relation of 401A=402A+403A is satisfied.

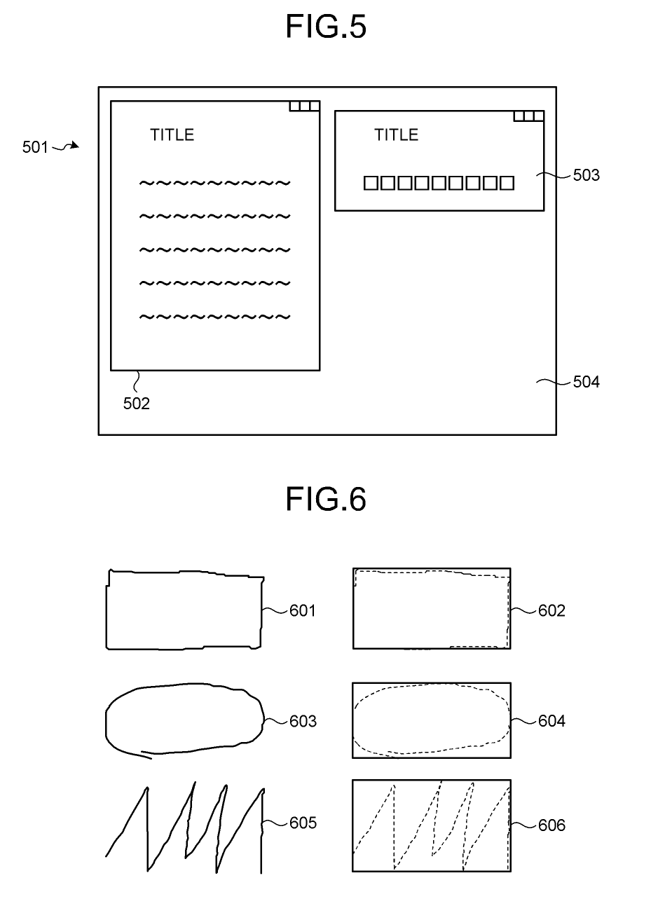

FIG. 5 is a plan view schematically illustrating another example of the first display region and the non-active region. Reference numeral 501 in FIG. 5 denotes the whole screen. Reference numerals 502 and 503 in FIG. 5 denote windows corresponding to programs (first contents) that are being executed. Reference numeral 504 in FIG. 5 denotes the non-active region. As illustrated in FIG. 5, when the windows corresponding to equal to or more than two programs that are being executed are displayed on the screen, these windows are collectively set as the first display region and the acquisition unit 102 acquires the region information enabling such first display region to be specified.

The acquisition unit 102 supplies the region information acquired from the display controller 104 to the first determination controller 103.

Description is continued with reference to FIG. 1 again. The first determination controller 103 determines the position of a graphic formed by the coordinate values received by the first receiver 101 such that the graphic is put in the above-mentioned non-active region, and determines the region on which the graphic is arranged in the non-active region to be a second display region. In the embodiment, the first determination controller 103 determines the position of the graphic formed by the respective coordinate values included in the drawn image data received by the first receiver 101 (in the following description, referred to as “graphic” simply in some cases) such that the graphic is put in the non-active region based on the drawn image data and the region information received from the acquisition unit 102. Then, the first determination controller 103 determines the region on which the graphic (graphic of which position has been determined) is arranged in the non-active region to be the second display region.

As illustrated in FIG. 6, a rectangle circumscribing the drawn image data can be set as the graphic. The circumscribing rectangle indicates a rectangle obtained by setting a minimum x coordinate and a minimum y coordinate as upper left coordinates, setting a difference between a maximum x coordinate and the minimum x coordinate as the width of the rectangle, and setting a difference between a maximum y coordinate and the minimum y coordinate as the height of the rectangle with reference to the minimum and maximum x coordinates and the minimum and maximum y coordinates from the coordinate group included in the drawn image data. In the example of FIG. 6, reference numeral 602 denotes a rectangle circumscribing drawn image data 601, reference numeral 604 denotes a rectangle circumscribing drawn image data 603, and reference numeral 606 denotes a rectangle circumscribing drawn image data 605.

In the embodiment, the first determination controller 103 sets the rectangle circumscribing the drawn image data received by the first receiver 101 as the above-mentioned graphic, and determines the position of the graphic such that the set graphic is put in the non-active region specified by the region information received from the acquisition unit 102. Although the first determination controller 103 receives the region information from the acquisition unit 102 in the embodiment, the first determination controller 103 is not limited to receive the region information in this manner. Alternatively, the first determination controller 103 may acquire the region information from the display controller 104, for example. In this case, the acquisition unit 102 is not required to be provided.

Although the graphic formed by the coordinate values received by the first receiver 101 is expressed as the rectangle that includes therein the coordinate values received by the first receiver 101 such that the area of the rectangle is minimum in the embodiment, as described above, the graphic is not limited thereto. For example, a result obtained by performing anti-aliasing processing by which a contour is made smoother than that of the drawn image data received by the first receiver 101 can be set as the above-mentioned graphic. Furthermore, a result obtained by performing graphic recognition on the drawn image data can be set as the above-mentioned graphic. A representative example of the graphic recognition is a method using pattern recognition and various shapes such as rectangles, ellipses, and triangles can be recognized thereby.

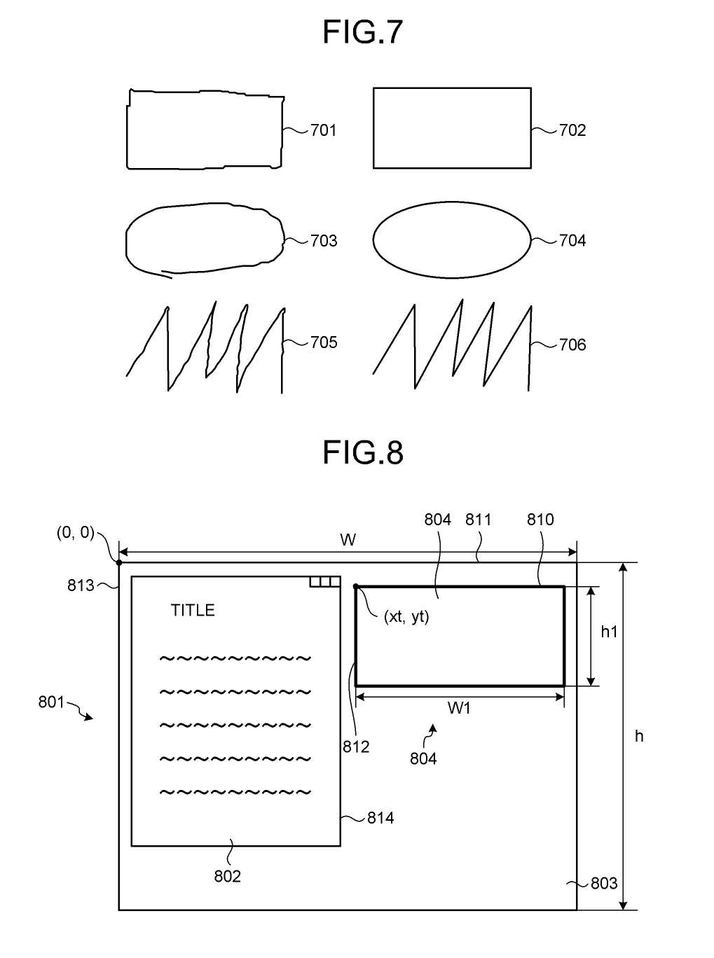

FIG. 7 illustrates an example when the result obtained by performing the graphic recognition on the drawn image data is set as the above-mentioned graphic. In the example of FIG. 7, reference numeral 702 denotes a result obtained by performing the graphic recognition on drawn image data 701, reference numeral 704 denotes a result obtained by performing the graphic recognition on drawn image data 703, and reference numeral 706 denotes a result obtained by performing the graphic recognition on drawn image data 705. In the case of the drawn image data 706, a start point and an end point are distanced from each other and an area of the graphic cannot be calculated because a closed region is not present when a result obtained by performing the anti-aliasing processing or the graphic recognition is set as the graphic. To address this, when the area of the set graphic cannot be calculated and when equal to or more than two closed regions are included, as described above with reference to FIG. 6, a plurality of methods including a method in which the rectangle circumscribing the drawn image data is reset as the above-mentioned graphic can be used in combination as the setting method. The setting method is not necessarily limited to the above-mentioned method.

Furthermore, in the embodiment, the first determination controller 103 determines the size of the above-mentioned graphic variably based on the distances between the edges of the graphic and the edges of the screen or the distances between the edges of the graphic and the edges of the first display region. To be more specific, the first determination controller 103 determines the size of the above-mentioned graphic such that the edge of the graphic reaches the edge of the screen when the first display region is not present between the edge of the graphic and the edge of the screen and the distance between the edge of the graphic and the edge of the screen is equal to or smaller than a threshold. In addition, the first determination controller 103 determines the size of the above-mentioned graphic such that the edge of the graphic reaches the edge of the first display region when the first display region is present between the edge of the graphic and the edge of the screen and the distance between the edge of the graphic and the edge of the first display region is equal to or smaller than a threshold. The processing is referred to as “size determination processing” in some cases in the following description. Then, the first determination controller 103 determines a region on which the graphic of which position and size have been determined is arranged in the screen to be the second display region displaying a second content.

Hereinafter, detail contents of the first determination controller 103 are described with reference to FIG. 8. Reference numeral 801 in FIG. 8 denotes the whole screen. Reference numeral 802 in FIG. 8 denotes the first display region. Reference numeral 803 in FIG. 8 denotes the non-active region. Reference numeral 804 in FIG. 8 denotes the above-mentioned graphic (rectangle circumscribing the drawn image data in this example). In the example of FIG. 8, an upper left corner of the screen is set to a point of origin (0, 0), and respective values of the x coordinate and the y coordinate are increased to the positive sides as they are closer to a lower right corner. In the example of FIG. 8, the width of the screen is set to w and the height thereof is set to h.

In the example of FIG. 8, it is assumed that the coordinates of the upper left apex of the graphic 804 are (xt, yt), the width of the graphic 804 is w1, and the height of the graphic 804 is h1. First, the first determination controller 103 determines whether the graphic 804 and the first display region 802 overlap with each other by comparing the coordinate values of the graphic 804 and the coordinate values of the first display region 802. When the first determination controller 103 determines that they do not overlap with each other, the first determination controller 103 determines whether the distances between the edges of the graphic 804 and the edges of the screen or the distances between the edges of the graphic 804 and the edges of the first display region 802 are equal to or smaller than a threshold.

As is described by taking an example, in the example of FIG. 8, the first display region 802 is not present between an upper edge 810 of the graphic 804 and an upper edge 811 of the peripheral edge of the screen 801 that is the closest to and is opposed to the upper edge 810 of the graphic 804. Based on this, the first determination controller 103 determines whether the distance between the upper edge 810 of the graphic 804 and the upper edge 811 of the screen 801 in the y direction is equal to or smaller than a threshold. To be more specific, the first determination controller 103 determines whether a distance (=yt) between “yt” indicating the y coordinate of the upper edge 810 of the graphic 804 and “0” indicating the y coordinate of the upper edge 811 of the screen 801 is equal to or smaller than the threshold. The threshold can be set by various methods. For example, the defined number of pixels can be set as the threshold, or a value corresponding to approximately 10% of the height h of the screen 801 can be also set as the threshold.

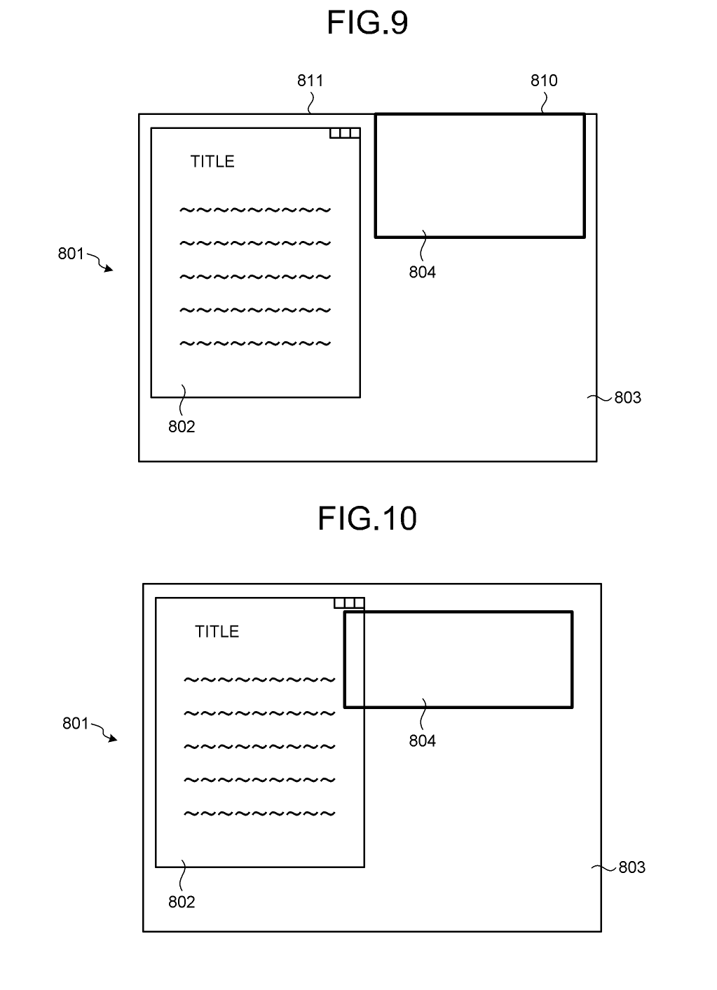

Then, when the first determination controller 103 determines that the distance between “yt” indicating the y coordinate of the upper edge 810 of the graphic 804 and “0” indicating the y coordinate of the upper edge 811 of the screen 801 is equal to or smaller than the threshold, it changes the size of the graphic 804 such that the upper edge 810 of the graphic 804 reaches the upper edge 811 of the screen 801, as illustrated in FIG. 9. In the example of FIG. 9, the first determination controller 103 changes the coordinates of the upper left apex of the graphic 804 from (xt, yt) to (xt, 0). This enlarges the height of the graphic 804 from h1 to h1+yt. On the other hand, when the first determination controller 103 determines that the distance between “yt” indicating the y coordinate of the upper edge 810 of the graphic 804 and “0” indicating the y coordinate of the upper edge 811 of the screen 801 is larger than the threshold, it does not perform the change as illustrated in FIG. 9.

Another example is described with reference to FIG. 8 again. In the example of FIG. 8, the first display region 802 is present between a left edge 812 of the graphic 804 and a left edge 813 of the peripheral edge of the screen 801 that is the closest to and is opposed to the left edge 812 of the graphic 804. Based on this, the first determination controller 103 determines whether the distance between the left edge 812 of the graphic 804 and a right edge 814 of the peripheral edge of the first display region 802 that is the closest to and is opposed to the left edge 812 of the graphic 804 in the x direction is equal to or smaller than a threshold. The threshold can be set by various methods. For example, the defined number of pixels can be set as the threshold, or a value corresponding to approximately 10% of the width w of the screen 801 can be also set as the threshold.

Then, in the same manner as described above, when the first determination controller 103 determines that the distance between the x coordinate of the left edge 812 of the graphic 804 and the x coordinate of the right edge 814 of the first display region 802 is equal to or smaller than the threshold, it changes the size of the graphic 804 such that the left edge 812 of the graphic 804 reaches the right edge 814 of the first display region 802. On the other hand, when the first determination controller 103 determines that the distance between the x coordinate of the left edge 812 of the graphic 804 and the x coordinate of the right edge 814 of the first display region 802 is larger than the threshold, it does not perform the above-mentioned change.

The first determination controller 103 performs the pieces of processing same as the above-mentioned pieces of processing for other edges (lower edge, right edge) of the graphic 804.

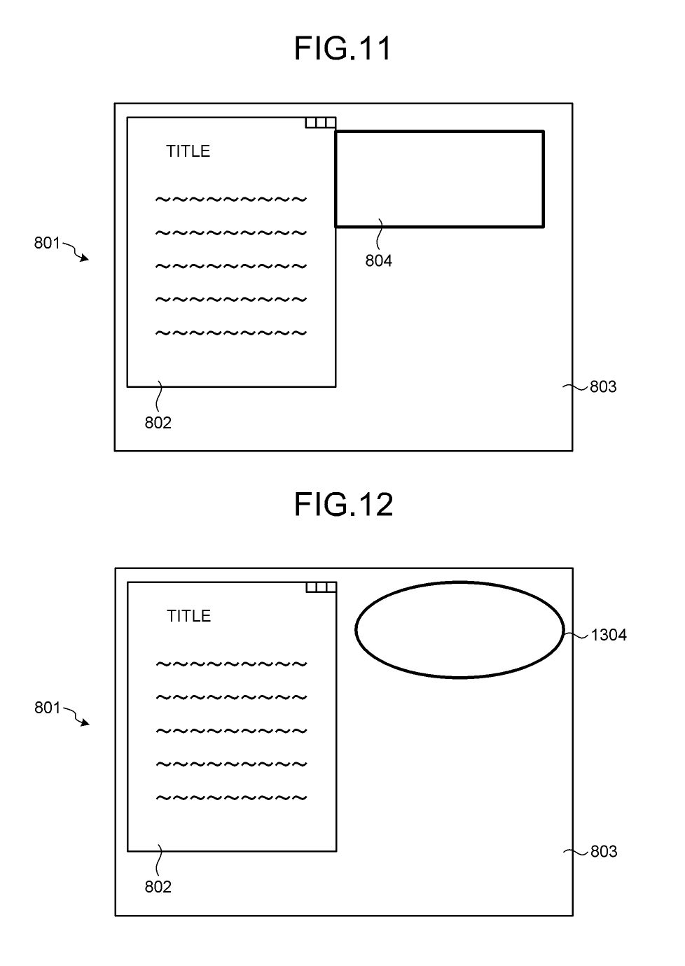

When the first determination controller 103 determines that the graphic 804 and the first display region 802 overlap with each other as illustrated in FIG. 10, it changes the size (width in the example of FIG. 11) of the graphic 804 such that the graphic 804 and the first display region 802 do not overlap with each other as illustrated in FIG. 11. In the example of FIG. 11, the first determination controller 103 performs the size change by cutting the portion of the graphic 804 that overlaps with the first display region 802. The size change manner is not limited thereto and the first determination controller 103 can also change the position of the graphic 804 such that the graphic 804 is put in the non-active region 803 so as not to overlap with the first display region 802 without changing the size of the graphic 804, for example. Then, the first determination controller 103 can also perform the above-mentioned size determination processing after changing the size and the position of the graphic 804 such that the graphic 804 does not overlap with the first display region 802.

Furthermore, in the case where the result obtained by performing the graphic recognition on the drawn image data is set as the above-mentioned graphic unlike the embodiment, the result same as the above-mentioned result can be obtained by calculating a rectangle circumscribing a set graphic 1304 and using it for the above-mentioned size determination processing even when the graphic 1304 is not rectangle as illustrated in FIG. 12.

Description is continued with reference to FIG. 1, again. The display controller 104 controls to display images of various types on a display unit (not illustrated). In the embodiment, the display controller 104 controls to display the second content indicating a program different from the first content on the second display region. Furthermore, the display controller 104 also sets the above-mentioned region information. When the second content is determined previously, the display controller 104 controls to display the content. On the other hand, when the second content is not determined, the display controller 104 controls to display the second display region by adding an effect enabling the user to visually check the second display region. Examples of the method of displaying the second content are as follows. The second content that is displayed so as to be put in the second display region may be displayed in an enlarged or contracted manner. Alternatively, the second content may be displayed without changing an enlargement rate and a position at which a command button or the like is displayed in the content may be changeable by adding a scroll bar and the like. The method of displaying the second content is not necessarily limited to them.

Examples of the effect include various methods such as a method by highlighting the outer circumference of the second display region with a line, a dotted line, or the like (method by highlight display) and a method by filling the second display region with a certain color. The transmittance of the certain color may be set such that the background of the non-active region can be observed in a see-through manner. In summary, the display controller 104 can control to highlight the second display region for display, and control to fill the second display region with the certain color of which transmittance is set for display. In addition, the display controller 104 may determine arrangement of the command button in the content in accordance with the shape of the display region. To be more specific, the command button can be arranged around the upper right coordinates of the rectangle circumscribing the second display region.

The hardware configuration of the above-mentioned display control device 1 is a hardware configuration using a computer including a central processing unit (CPU), a storage device such as a read only memory (ROM) and a random access memory (RAM), a display device, and an input device. The CPU executes programs stored in the storage device so as to execute the functions of the respective parts (first receiver 101, acquisition unit 102, first determination controller 103, and display controller 104) of the above-mentioned display control device 1. The respective parts are not limited to be executed in this manner and at least a part of the functions of the respective parts of the above-mentioned display control device 1 may be executed by a hardware circuit (for example, semiconductor integrated circuit). Furthermore, the display control device 1 in the embodiment may be configured by a personal computer (PC), a tablet terminal, or a mobile terminal.

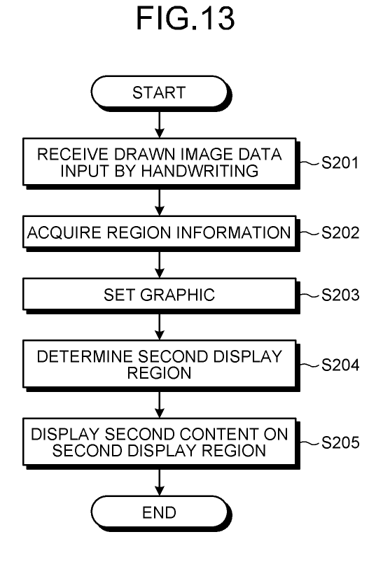

Next, an example of operations of the display control device 1 in the embodiment is described. FIG. 13 is a flowchart illustrating the example of the operations of the display control device 1. As illustrated in FIG. 13, first, the first receiver 101 receives drawn image data input by handwriting (step S201). Then, the acquisition unit 102 acquires the above-mentioned region information from the display controller 104 (step S202). The first determination controller 103 sets a rectangle circumscribing the drawn image data received at step S201 as the above-mentioned graphic (step S203). Subsequently, the first determination controller 103 determines the position of the graphic set at step S203 such that the graphic is put in a non-active region specified by the region information acquired at step S202, and performs the above-mentioned size determination processing so as to determine the size of the graphic. Then, the first determination controller 103 determines a region on which the graphic of which position and size have been determined is arranged on the screen to be a second display region (step S204). Thereafter, the display controller 104 controls to display a second content on the second display region (step S205).

As described above, in the embodiment, the position of the rectangle (graphic) circumscribing the drawn image data input by handwriting is determined such that the rectangle is put in the non-active region, and the region on which the rectangle is arranged on the screen is set as a region displaying the second content. This can achieve an advantageous effect that the region displaying the second content can be set to have the appropriate size in accordance with input by the user.

In the embodiment, the size of the rectangle is determined variably based on the distances between the edges of the rectangle and the edges of the screen or the distances between the edges of the rectangle and the edges of the first display region displaying the first program that is being executed. To be more specific, the size of the rectangle is determined such that the edge of the rectangle reaches the edge of the screen when the first display region is not present between the edge of the rectangle and the edge of the screen and the distance between the edge of the rectangle and the edge of the screen is equal to or smaller than a threshold. In addition, the size of the rectangle is determined such that the edge of the rectangle reaches the edge of the first display region when the first display region is present between the edge of the rectangle and the edge of the screen and the distance between the edge of the rectangle and the edge of the first display region is equal to or smaller than a threshold. That is to say, in the embodiment, when a margin region between the edge of the rectangle and the edge of the screen or a margin region between the edge of the rectangle and the edge of the first display region is smaller than a predetermined size, the second display region is set so as to include the margin region therein. This can ensure a sufficient size of the second display region.

### Modification of First Embodiment

For example, when the first receiver 101 receives input directing to generate the non-active region while the non-active region is not present (condition where the whole region of the screen is the first display region), the display controller 104 can also change the first display region so as to generate the non-active region. Then, when the non-active region has been generated, input by handwriting is received. Subsequently, the same pieces of processing as those in the above-mentioned first embodiment are performed. As the input directing to generate the non-active region, various modes such as flick input by tracing the screen from right to left, from left to right, from up to down, and from down to up with a user's finger or a pen, handwriting input of symbol marks like “←”, “→”, “↓”, and “↑”, and input by tapping the screen by a predetermined number of times (for example, three times) can be employed.

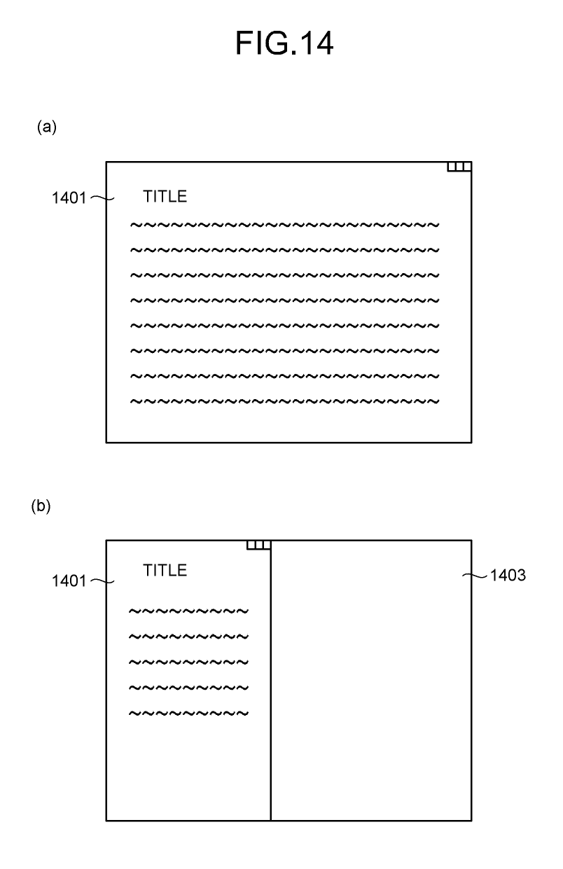

The first display region is changed in the following manners, for example. That is, when the whole region of the screen is a first display region 1401 (in other words, the first content that is being executed is displayed on the whole screen) as illustrated in (a) of FIG. 14, if the first receiver 101 receives the input directing to generate the non-active region, the display controller 104 changes the first display region 1401 so as to generate a non-active region 1403 as illustrated in (b) of FIG. 14. As the changing method, the non-active region may be previously defined so as to have a specific size or the active region may be set to be generated on a left half portion, a right half portion, an upper half portion, or a lower half portion in accordance with the input.

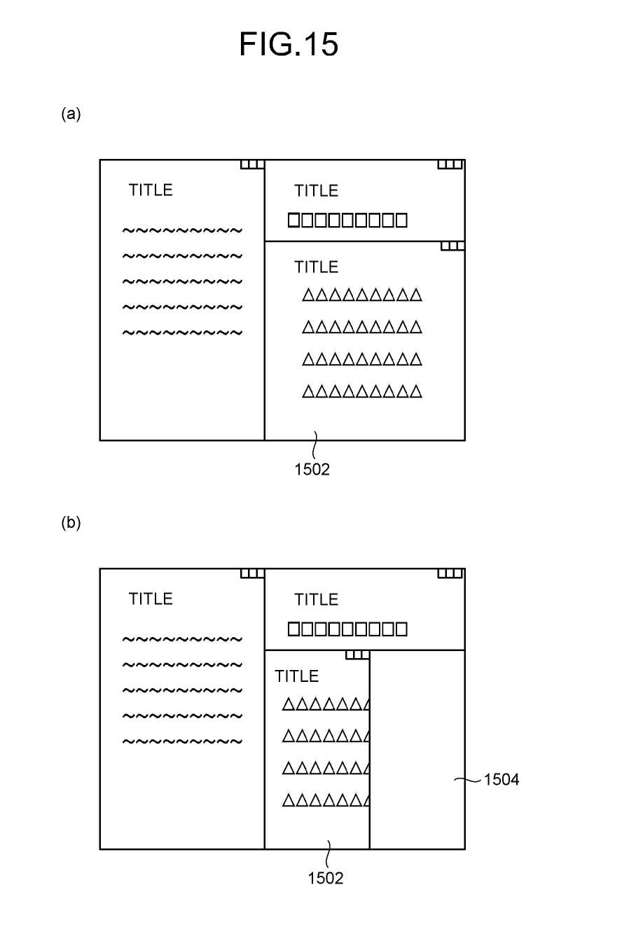

As illustrated in (a) of FIG. 15, when a plurality of windows (first display regions) occupy the whole region of the screen and the non-active region is not present, if the input that is the same as the above-mentioned input is received in the region of a window 1502, for example, as illustrated in (b) of FIG. 15, only the size of the window 1502 can be made smaller so as to generate a non-active region 1504.

For example, a mode in which the first receiver 101 receives the input only when input directing to generate the non-active region is made onto a specific region in the screen may be employed. The specific region may be set by any method. For example, a region that does not inhibit the functions of the first contents while being executed even when the user performs an operation (handwriting operation, flick operation, tap operation, or the like) for making the input directing to generate the non-active region is preferably set as the specific region.

### Second Embodiment

Next, a second embodiment is described. In the second embodiment, it is assumed that the second content is not determined previously and the second content is determined after the second display region is determined. Description of the parts common to those in the above-mentioned first embodiment is omitted appropriately.

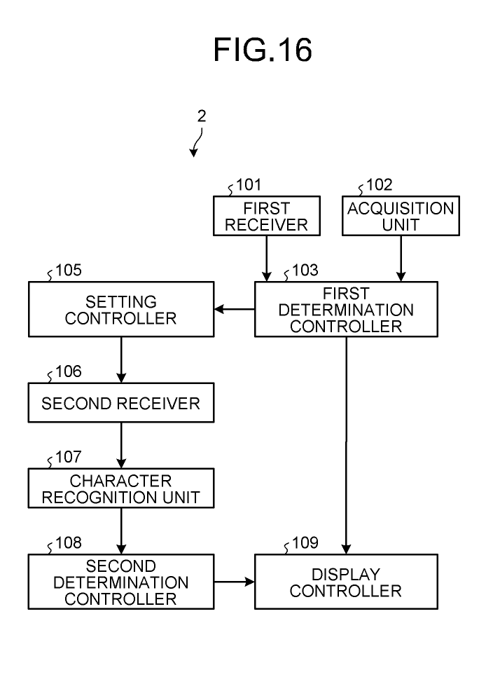

FIG. 16 is a diagram illustrating an example of the functional configuration of a display control device 2 in the second embodiment. As illustrated in FIG. 16, the display control device 2 further includes a setting controller 105, a second receiver 106, a character recognition unit 107, and a second determination controller 108.

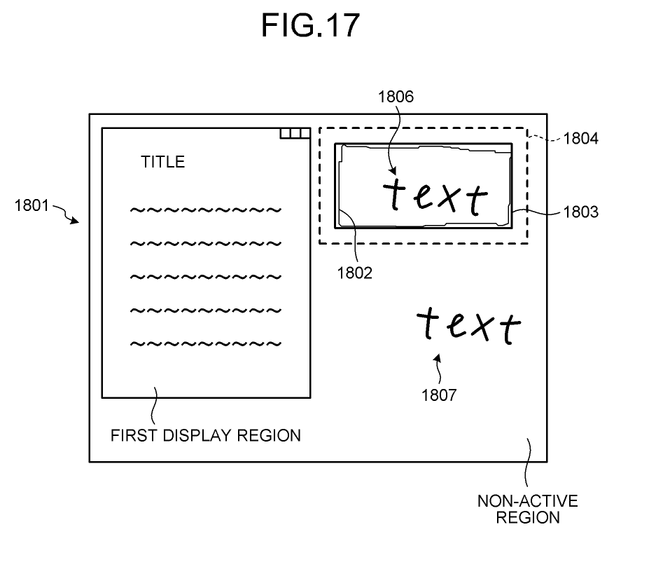

The setting controller 105 sets at least a partial region of the screen as a character input region after the first determination controller 103 determines the second display region. In the embodiment, the setting controller 105 sets a region corresponding to the second display region on the screen as the character input region. The setting controller 105 can set the second display region (in this example, region in a rectangle 1803 circumscribing a graphic formed by respective coordinate values included in drawn image data 1802 input by handwriting on a screen 1801) as the character input region as it is. Alternatively, the setting controller 105 can also set a certain range 1804 including the rectangle 1803 on the screen 1801 as the character input region as illustrated in FIG. 17, for example. The character input region is not limited to be set in the above-mentioned manners. For example, a mode in which the setting controller 105 is not provided and the whole region of the screen is used as the character input region may be employed.

The second receiver 106 receives coordinate values on the screen that have been input in time series in accordance with the operation by the user after the first determination controller 103 determines the second display region. In the embodiment, the second receiver 106 receives only the coordinate values in the character input region input in time series in accordance with the operation by the user. That is to say, the second receiver 106 receives only drawn image data input by handwriting onto the character input region set by the setting controller 105. For example, in FIG. 17, the certain range 1804 including the rectangle 1803 is assumed to be set as the character input region. In this case, the second receiver 106 receives only drawn image data 1806 input by handwriting onto the range 1804 including the rectangle 1803 after the second display region is determined while it does not receive drawn image data 1807 input by handwriting onto the outside of the range 1804.

It should be noted that the above-mentioned first receiver 101 may also function as the second receiver 106 without providing the second receiver 106, for example.

The character recognition unit 107 recognizes whether the trajectory of the coordinate values received by the second receiver 106 expresses a character. In the embodiment, the character recognition unit 107 determines any one of the character, the graphic, and the table to which each stroke forming the drawn image data received by the second receiver 106 belongs so as to recognize whether the drawn image data received by the second receiver 106 expresses the character. The character recognition unit 107 calculates the likelihood with respect to each stroke using a discriminator, for example. Note that the discriminator is pre-learnt to determine any one of a character, a graphic, and a table to which each stroke belongs. Then, the character recognition unit 107 expresses the likelihood by Markov random field (MRF) in order to couple with spatial proximity and continuity on a document plane (in this example, screen). By estimating a region with the highest discreteness, the strokes can be also divided into a character region, a graphic region, and a table region (for example, X.-D. Zhou, C.-L. LiU, S. Ouiniou, E. Anquetil, “Text/Non-text lnk Stroke Classification in Japanese Handwriting Based on Markov Random Fields” ICDAR'07 Proceedings of the Ninth International Conference on Document Analysis and Recognition, vol. 1, pp. 377-381, 2007).

When the character recognition unit 107 recognizes that the trajectory of the coordinate values received by the second receiver 106 expresses the character, the second determination controller 108 determines the program corresponding to the character expressed by the trajectory of the coordinate values received by the second receiver 106 as the second content. To be more specific, when it is recognized that the trajectory of the coordinate values received by the second receiver 106 expresses the character, the second determination controller 108 converts the trajectory (drawn image data) of the coordinate values received by the second receiver 106 to text data, and determines a content corresponding to the converted text data as the second content. The text data is formed by a standard called “character code” and is used when data is input from a keyboard or the like. To be specific, when the drawn image data 1806 as illustrated in FIG. 17 is input, the input drawn image data 1806 is converted into text data of “text”, and then, a matched content on a content list can be determined as the second content. When there is no matching content, a content having the highest matching rate can be determined as the second content. When a plurality of contents can be candidates, a content displaying the plurality of contents as the candidates can be also determined as the second content. When no candidate is found, a content displaying a character string “please input again” can be also determined as the second content. Furthermore, the drawn image data input by handwriting is not limited to indicate a program name and may indicate a file name, for example. In addition, when respective contents and drawn images such as characters, graphics, and marks corresponding to the contents are registered previously, various methods including a method in which the registered contents are used for determining the second content can be employed and the method of determining the second content is not necessarily limited to the above-mentioned methods.

The hardware configuration of the above-mentioned display control device 2 is a hardware configuration using a computer including a CPU, a storage device such as a ROM and a RAM, a display device, and an input device. The CPU executes programs stored in the storage device so as to execute the functions of the respective parts (first receiver 101, acquisition unit 102, first determination controller 103, display controller 104, setting controller 105, second receiver 106, character recognition unit 107, and second determination controller 108) of the above-mentioned display control device 2. The respective parts are not limited to be executed in this manner and at least a part of the functions of the respective parts of the above-mentioned display control device 2 may be executed by a hardware circuit (for example, semiconductor integrated circuit). Furthermore, the display control device 2 in the embodiment may be configured by a personal computer (PC), a tablet terminal, or a mobile terminal.

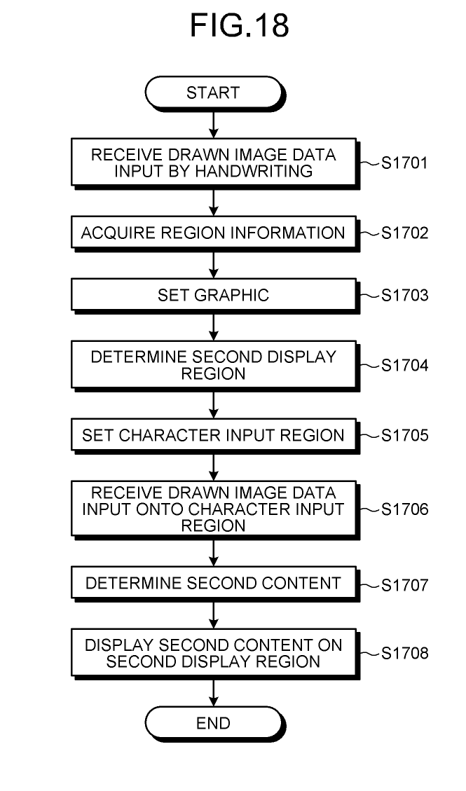

Next, an example of operations of the display control device 2 in the embodiment is described. FIG. 18 is a flowchart illustrating the example of the operations of the display control device 2. The processing contents at step S1701 to step S1704 as illustrated in FIG. 18 are the same as the processing contents at step S201 to step S204 as illustrated in FIG. 13, and detail description thereof is omitted.

After the processing at step S1704, the setting controller 105 sets the above-mentioned character input region (step S1705). Then, the second receiver 106 receives drawn image data input by handwriting onto the character input region set at step S1705 (step S1706). The second determination controller 108 determines the second content (step S1707). To be more specific, as described above, when the character recognition unit 107 recognizes that the drawn image data received at step S1706 expresses a character, the second determination controller 108 determines the program corresponding to the character expressed by the drawn image data received at step S1706 as the second content. Subsequently, the display controller 104 controls to display the second content on the second display region (step S1708). The display controller 104 can also control to display the second display region by adding an effect enabling the user to visually recognize the second display region until the second content is determined at step S1707 after the second display region is determined at step S1704 as illustrated in FIG. 18.

For example, a configuration in which a first mode corresponding to the above-mentioned first embodiment and a second mode corresponding to the above-mentioned second embodiment are included as operation states (modes) of the display control device, and the operation mode can be switched to any one of the modes based on an operation by the user or whether a specific condition is satisfied may be used.

### Computer Program

The programs that are executed on the above-mentioned display control device (1 or 2) may be stored in a computer connected to a network such as the Internet and provided by being downloaded via the network, as a computer program product. Furthermore, the programs that are executed on the above-mentioned display control device (1 or 2) may be provided or distributed via a network such as the Internet, as a computer program product. In addition, the programs that are executed on the above-mentioned display control device (1 or 2) may be embedded and provided in a ROM, for example, as a computer program product.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display control device comprising:
a first receiver configured to receive a first set of coordinate values on a screen, the first set of coordinate values being input in a time series based on an operation by a user;
a first determination controller configured to position a graphic formed by the first set of coordinate values such that the graphic is placed in a non-active display region, the non-active display region being other than a first display region in which a first content indicative of a program that is being executed is displayed on the screen, and to set a portion of the non-active display region in which the graphic is arranged as a second display region; and
a display controller configured to display a second content indicative of a program different from the first content in the second display region.

2. The device according to claim 1, wherein the first determination controller is configured to determine a size of the graphic variably in accordance with a distance between an edge of the graphic and an edge of the screen or a distance between an edge of the graphic and an edge of the first display region.

3. The device according to claim 2, wherein
the first determination controller is configured to determine the size of the graphic such that the edge of the graphic reaches the edge of the screen when the first display region is not present between the edge of the graphic and the edge of the screen and the distance between the edge of the graphic and the edge of the screen is equal to or smaller than a first threshold, and
the first determination controller is configured to determine the size of the graphic such that the edge of the graphic reaches the edge of the first display region when the first display region is present between the edge of the graphic and the edge of the screen and the distance between the edge of the graphic and the edge of the first display region is equal to or smaller than a second threshold.

4. The device according to claim 1, wherein the graphic indicates a rectangle that includes the coordinate values received by the first receiver such that an area of the rectangle is minimum.

5. The device according to claim 1, wherein the display controller is configured to highlight the second display region for display.

6. The device according to claim 1, wherein the display controller is configured to fill the second display region with a certain color of which transmittance is set for display.

7. The device according to claim 1, wherein the display controller is configured to change the first display region so as to generate the non-active display region when the non-active display region is not present and the first receiver receives input directing to generate the non-active display region.

8. The device according to claim 1, further comprising:
a second receiver configured to receive a second set of coordinate values on the screen, the second set of coordinate values being input in a time series based on an operation by the user, after the first determination controller determines the second display region;
a character recognition controller configured to recognize whether a trajectory of the second set of coordinate values expresses a character; and
a second determination controller configured to determine, as the second content, a program corresponding to the character expressed by the trajectory of the second set of coordinate values when the character recognition controller recognizes that the trajectory of the second set of coordinate values expresses the character.

9. The device according to claim 8, further comprising a setting controller configured to set at least a partial region of the screen as a character input region after the first determination controller determines the second display region, wherein
the second receiver is configured to receive coordinate values in the character input region input in a time series based on an operation by the user.

10. The device according to claim 9, wherein the setting controller is configured to set a region corresponding to the second display region on the screen as the character input region.

11. A display control method of a display control device comprising:
receiving coordinate values on a screen, the coordinate values being input in a time series based on an operation by a user;
positioning a graphic formed by the coordinate values such that the graphic is placed in a non-active display region, the non-active display region being other than a first display region in which a first content indicative of a program that is being executed is displayed on the screen;
setting a portion of the non-active display region in which the graphic is arranged as a second display region; and
displaying a second content indicative of a program different from the first content in the second display region.

12. A computer program product comprising a non-transitory computer-readable medium containing a program executed by a computer, the program causing the computer to execute:
receiving coordinate values on a screen, the coordinate values being input in a time series based on an operation by a user;
positioning a graphic formed by the coordinate values such that the graphic is placed in a non-active display region, the non-active display region being other than a first display region in which a first content indicative of a program that is being executed is displayed on the screen;
setting a portion of the non-active display region in which the graphic is arranged as a second display region; and
displaying a second content indicative of a program different from the first content in the second display region.
